(19) United States
(12) Patent Application Publication
(10) Pub. No.: US 2026/0077674 A1
(43) Pub. Date: Mar. 19, 2026

(54) METHOD FOR CHARGING A PLURALITY OF ELECTRICALLY DRIVEN MOTOR VEHICLES VIA A COMMON CHARGING STATION

(71) Applicant: Alveri GmbH, Ried im Innkreis (AT)

(72) Inventors: Kabir Secibovic, Gunskirchen (AT); Anton Hinterreither, Weitersfelden (AT)

(21) Appl. No.: 19/106,929

(22) PCT Filed: Aug. 17, 2023
(86) PCT No.: PCT/AT2023/060279

§ 371 Date: Feb. 26, 2025

(30) Foreign Application Priority Data
Sep. 8, 2022 (AT) A 50682/2022

(51) Int. Cl. B60L 53/66; B60L 53/30; B60L 53/31; B60L 53/62

(52) U.S. Cl. CPC B60L 53/66; B60L 53/305; B60L 53/31; B60L 53/62

(57) ABSTRACT

In a method for charging electrically driven motor vehicles via a common charging station, charging current of the charging station is supplied to a charging distributor on its input side and to the motor vehicles via its output side through connection links, The battery status for each connected motor vehicle is determined after connection of the connection link. The serial charging of several electric vehicles with only one charging station estimates completion time of the charging process of each vehicle. The connected motor vehicles are then queued and the charging distributor, starting with the first motor vehicle in the queue as the selected motor vehicle, in a serial charging process via a transmitted enable signal for the charging current tap exclusively for the selected motor vehicle exclusively enables this motor vehicle to tap the charging current until the battery status of that motor vehicle corresponds to a setpoint value stored in the charging distributor, whereupon the serial charging process is carried out for the next motor vehicle in the queue as the selected motor vehicle.

### FIELD OF THE INVENTION

The invention relates to a method for charging a plurality of electrically driven motor vehicles via a common charging station, in which the charging current of the charging station is supplied to a charging distributor on its input side and the charging current is supplied to the motor vehicles to be charged via the output side of the charging distributor through connection links, the battery status for each connected motor vehicle being determined after the connection of the connection link.

### DESCRIPTION OF THE PRIOR ART

Devices are known from the state of the art with which the charging current of a single charging station for electrically powered motor vehicles can be distributed to several motor vehicles via a charging distributor. It is known that the vehicles signal their battery status, for example via an internal resistor that can be switched to different levels depending on the charging current requirement. It is also known from DE102019217783A1 to electrically connect several vehicles to the charging distributor via one connection link each, whereby each connection link is assigned a switch with which the charging current tap of the vehicle can be interrupted. If an end-of-charging signal is received from a first vehicle, the switch of the connection link connected to the first vehicle is switched so that this connection link is current-blocking. The switch of the connection link connected to the second vehicle is switched so that this connection link is conducting current, whereupon the charging process of the second car is started.

However, a disadvantage of the state of the art is that a switch must be provided for each connection link. This increases the cost, complexity and susceptibility to errors of the charging process, especially if there are several connection links. In addition, the failure of the switch makes it impossible to use the respective connection link without first repairing or replacing the switch. Furthermore, the vehicles are supplied with charging current according to the switching sequence of the switches, which means that if different vehicles are repeatedly connected and disconnected, even a vehicle that has already been connected for a long time will still not be supplied with charging current if another vehicle is connected to a different connection link.

### SUMMARY OF THE INVENTION

The invention is thus based on the task of enabling reliable serial charging of several electric vehicles with only one charging station using the simplest possible technical means and at the same time being able to traceably estimate or determine the completion time of the charging process of each vehicle.

The invention solves the task set by the fact that the connected motor vehicles are then queued and the charging distributor, starting with the first motor vehicle in the queue as the selected motor vehicle, exclusively enables this motor vehicle to tap the charging current-in a serial charging process by means of a transmitted enable signal for the charging current tap exclusively for the selected motor vehicle-until the battery status of this motor vehicle corresponds to a setpoint value stored in the charging distributor, whereupon the serial charging process is carried out for the next motor vehicle in the queue as the selected motor vehicle. The invention is based on the idea that the possibility of a charging current tap for a motor vehicle from the connection link is not established via a separate circuit, such as a switch, and that this connection link is thus interrupted to prevent an undesired charging current tap. Instead, each of the connected motor vehicles is continuously connected to the charging distributor for the duration of the connection, but the charging circuit is exclusively closed for one connected motor vehicle by transmitting the enable signal. Although the enable signal can be transmitted to all connected motor vehicles, it is specific to the respective motor vehicle and only enables the charging current tap for one motor vehicle in the order until the battery status at least corresponds to a setpoint value stored in the charging distributor. The enable signal causes an internal switching process in the selected motor vehicle, whereby the connection link becomes part of a charging circuit of the motor vehicle, in which the charging current coming from the charging station via the charging distributor and the connection link causes the battery of the motor vehicle to be charged. This enable signal can be provided, for example, via an electrical signal that informs the selected motor vehicle of the charging current that can be drawn. The battery status can be determined, for example, by the change in an internal resistance in a common circuit with the charging distributor. If the battery status of the motor vehicle currently selected in the queue does not correspond to the setpoint value, the enable signal for this motor vehicle is transmitted, whereby this motor vehicle is enabled for the charging current tap. In the simplest case, the setpoint value can only be one value, namely “fully charged”. Preferably, however, the battery status and setpoint value refer to percentages of charge. For example, the battery status can include the charge status of the motor vehicle battery as a percentage of the maximum capacity and the setpoint can be the lower limit of the charge status to be achieved for this battery as a percentage of the maximum capacity, e.g. “at least 20%”. In this case, an enable signal is then transmitted for the selected motor vehicle until the state of charge of the battery is at least 20%. The setpoint can be specified or changed by an administrator via an interface on the charging distributor, for example. The queueing of the connected vehicles allows the connected motor vehicles to be charged in a sequence that is independent of the arrangement of the connection links, as the sequence is not predetermined by mechanical or electronic components. For example, the number of a parking space assigned to a connection link can define the place in the loading queue. The queue can be updated at certain times, for example each time a connection link is established or released. The motor vehicles can be charged in sequence, with the charging process being stopped when the battery status of all connected motor vehicles corresponds to the setpoint value. It goes without saying that in the case of a single connected motor vehicle, this is the first vehicle in the series and is charged first. The connection link must at least allow the charging current provided by the charging station to be conducted from the charging distributor to the connected motor vehicle. However, it can also include other lines for data exchange between the motor vehicle and the charging distributor. Furthermore, the charging distributor can be in contact with each motor vehicle connected via a connection link for the duration of the connection via the communication means used to transmit the enable signal. The charging distributor can repeatedly determine the battery status of the motor vehicle being charged and repeatedly compare it with the setpoint value. According to the invention, the connection links can be designed to be particularly simple and switch-free, as charging current and any other signals can be applied to all connection links and no current or signal separation is required for the different connection links. This makes it possible to connect the connection links in parallel. Nevertheless, according to the invention, only one motor vehicle is charged at a time, i.e. a serial charging process is carried out. In particular, the connection links are connected in parallel (without a switch) to a common charging distributor. By transmitting the enable signal for the charging current tap exclusively for the selected motor vehicle, a charging current tap can be enabled for this motor vehicle in a serial charging process until the battery status of this motor vehicle corresponds to a setpoint value stored in the charging distributor. The next vehicle in the queue is then charged by transmitting an enable signal for the charging current tap exclusively to this vehicle. The charging distributor therefore only needs to be designed for the maximum charging capacity of a vehicle.

In order to not only transmit information to the motor vehicle with the enable signal as to whether or not it is allowed to tap charging current, but also to enable more complex data exchange, it is proposed that the enable signal for the charging current tap is transmitted as a modulated voltage signal. This allows further information to be added to the enable signal via the modulation and thus transmitted to the motor vehicle. For example, the maximum amount of charging current that can be tapped by the motor vehicle can be communicated via the duty cycle of the pulse width modulation of the signal. For example, a pulse width modulation duty cycle of 10 to 85% can correspond to a permitted voltage tap of 6 amperes to 51 amperes, while a pulse width modulation duty cycle of less than 3% signals to the motor vehicle that it is not allowed to tap any charging current. For this the enable signal can include the pilot signal of the charging station and the information as to which motor vehicle is to be enabled, for example.

In order to create the possibility of giving priority to motor vehicles that need to be charged urgently, regardless of the queueing of the motor vehicles, it is proposed that a prioritized connection link is provided and, after the battery status of the motor vehicle connected to the prioritized connection link has been determined, the charging distributor interrupts the charging current tap running via another connection link and the serial charging process is restarted with the motor vehicle connected to the prioritized connection link as the first motor vehicle in the queue. As a result of these measures, the motor vehicle connected to the prioritized connection link is always charged first, regardless of the existing queue of the other motor vehicles. Provided that connecting to the prioritized connection link does not change the order of the remaining vehicles, it is still possible to estimate when a particular motor vehicle in the queue will be charged. The prioritized charging link can be provided for vehicles that need to be charged as quickly as possible, for example for customer or emergency vehicles, while more charging time is available for the vehicles on the regular connection links. It goes without saying that although more than one prioritized connection link can be provided, a further queueing must then be carried out for the multiple prioritized connection links, which is followed by the queueing of the regular connection links. The prioritized connection link does not have to be physically fixed to one connection link, but can change. For example, regular and preferred users can be recognized via a special authentication at the charging distributor, whereby the connection link that is connected to the motor vehicle of a preferred user automatically becomes the prioritized connection link. A separate setpoint may be provided for motor vehicles connected to prioritized connection links.

Although a large number of variants are possible according to which the motor vehicles can be ranked, the connected vehicles can be queued consecutively according to the time at which the connection link is connected in order to make the ranking traceable at all times and time-efficient for a maximum number of users. This means that motor vehicles connected later are loaded later. In this way, a user can determine how many motor vehicles are already connected when connecting the connection link to their motor vehicle and thus estimate the time at which their vehicle will be charged. Furthermore, the order of the motor vehicle is not predetermined by the spatial assignment of the connection link, for example a parking space, so that, apart from prioritized connection links, no motor vehicle connected later is loaded beforehand. As the connected motor vehicles are ranked according to the time at which the connection link is connected, a vehicle loses its place in the row as soon as the connection link is interrupted.

In order to use existing plug and signal systems and thus keep communication between the charging distributor and the motor vehicle as simple as possible, it is proposed that the charging distributor exclusively converts a pilot signal transmitted by the charging station into the enable signal for the charging current tap for the selected motor vehicle and the enable signal is transmitted via the connection links. As a result of these measures, separate data transmission systems for the enable signal are not necessary. This also allows the use of industry-standard plugs, such as CCS type 2 plugs, for the connection links for the motor vehicles, which, in addition to a charging current supply, also have a pilot contact for transmitting a pilot signal with the connected motor vehicle. This means that the battery status can also be determined via the connection link. The enable signal can be sent to all motor vehicles via all connection links. At the end of the connection link of the selected motor vehicle, the charging current tap of the vehicle is initialized based on the specific enable signal. In one possible embodiment, an identification signal specific to the selected motor vehicle is added by the charging distributor to the pilot signal of the charging station, which pilot signal usually enables the charging current to be released via a modulated voltage signal, in order to obtain the enable signal. Each connection link ends in a CCS type 2 plug, which includes a signal unit. The enable signal is now transmitted via all connection links and reaches the signal units of all connection links. The signal unit of the connection link to which the selected motor vehicle is connected recognizes from the identification signal that the enable signal applies to the selected motor vehicle and converts the enable signal back into a conventional pilot signal so that the selected motor vehicle receives the same information as if it were connected directly to the charging station.

In order to restrict access to selected or all connection links and thus both prevent unauthorized use and influence the queueing of connected motor vehicles, it is proposed, that the connection link is only established after user authentication. This user authentication can be carried out, for example, via an RFID transponder carried by the user. The connection link can only be connected to a motor vehicle once user authentication has been completed. For example, the connection link can be physically locked and released by user authentication. Prioritized connection links or connection links assigned to preferred parking spaces, for example, can also only be accessible via separate user authentication. Such separate user authentication can cause any connection link that is connected to the motor vehicle associated with the separate user authentication to become a prioritized connection link, regardless of the spatial arrangement of the connection link.

The invention also relates to a charging distributor for carrying out a method according to one of the above claims, comprising an input for the charging plug of a charging station, a plurality of connection links for supplying charging current to the motor vehicles, a receiver for determining the battery status of a connected motor vehicle, a computing unit for queueing the connected motor vehicles and a data link for transmitting an enable signal. The charging station's charging plug can be connected to the charging distributor via its input. The charging distributor, in turn, can be connected to several motor vehicles via its multiple connection links. The exact design of the receiver depends on how the battery status of the connected motor vehicles is determined. If a connected motor vehicle emits its battery status via a wireless signal, for example, the receiver comprises an antenna. Preferably, however, the battery status is transmitted via the connection link. In this way, the signal indicating the battery status can be further processed as a receiver by a signal converter connected to the connection link. The receiver transmits the battery status of the connected motor vehicles to the computer, which sends the enable signal via the data connection. The enable signal can be transmitted to all vehicles at the same time, as it only enables the charging current tap for the selected vehicle. For example, each connection link can end in a CCS type 2 plug, which includes a signal unit. The enable signal is now transmitted via all connection links and reaches the signal units of all connection links. The signal unit of the connection link to which the selected motor vehicle is connected recognizes from the identification signal that the enable signal applies to the selected motor vehicle and converts the enable signal back into a conventional pilot signal so that the selected motor vehicle receives the same information as if it were connected directly to the charging station.

In order to further simplify the charging current tap of the vehicles to be charged, the connection links can be connected in parallel. Since only the one connected motor vehicle for which the enable signal for the charging current tap has been transmitted can tap charging current by closing the circuit formed by the connection link, it is not necessary to actively interrupt or control the charging current tap, for example via switches. For the same reason, the enable signal can also be transmitted via the parallel-connected connection links.

To increase operational safety, a storage socket is provided for each connection link. The end of the connection link, preferably a plug, can be plugged into this storage socket when the connection link is not connected to a motor vehicle and can thus be stored safely. In a preferred embodiment, the charging distributor recognizes, for example via a circuit closed via the storage socket, that the end of the connection link is stored in the storage socket. If not all connection links are either connected to motor vehicles or stored in the storage sockets, the charging distributor can interrupt the power supply to the connection links in order to avoid unwanted electrical contact with people or objects and any resulting injuries or damage.

In order to provide the user with relevant information about the charging process, an indicator for reading the charging status of the connected motor vehicle can be provided for each connection link. The charging status can, for example, include information about the expected start and end of the charging process, current battery status, position of the connected motor vehicle in the row or similar information. In a preferred embodiment, the indicator is attached to a handle or plug arranged at the end of the connection link.

### BRIEF DESCRIPTION OF THE INVENTION

The drawing shows an example of the object of the invention, wherein

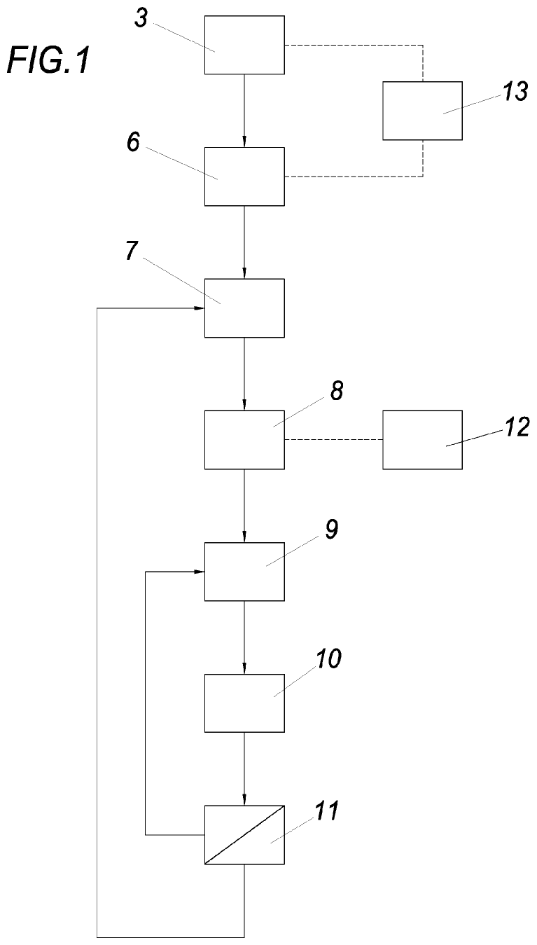

FIG. 1 shows a schematic diagram of the process according to the invention and

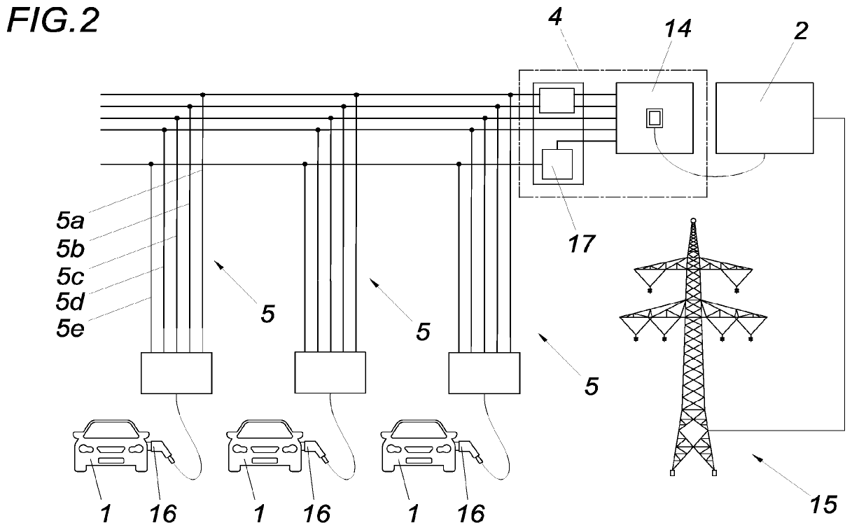

FIG. 2 shows a schematic view of a device for carrying out the method according to the invention.

### DESCRIPTION OF THE PREFERRED EMBODIMENT

In a method according to the invention for charging a plurality of electrically driven motor vehicles 1 via a common charging station 2, the charging current of the charging station 2 is fed to the input side of a charging distributor 4 in a first step 3. For this purpose, the charging distributor 4 has an input that is compatible with the charging plug of the charging station 2. In a preferred embodiment, the charging distributor 4 can have several inputs for different types of charging plugs. The charging distributor 4 has several connection links 5 on the output side, with the embodiment example shown having three connection links 5. If a connection link 5 is connected to a motor vehicle 1, the charging current of the charging station 2 can charge the battery of the motor vehicle 1 via the charging distributor 4 and the connection link 5. In a next step 6, one or more motor vehicles 1 are connected to the charging distributor 4 via the connection links 5, whereby this step 6 can be carried out at any time during the method. Since the method is trivial for only one connected motor vehicle 1, it is assumed in the description that several motor vehicles 1 are connected to the charging distributor 4. In the next step 7, the battery status of the motor vehicles 1 is determined. The battery status can be transmitted from the motor vehicles 1 to the charging distributor 4, for example via a radio signal or preferably via the connection link 5. In the subsequent step 8, the motor vehicles 1 ready for charging are queued; this can be done, for example, via the spatial assignment of the connection links 5 or preferably via the time at which the connection link 5 is connected to the respective motor vehicle 1. This sequence determines which motor vehicle 1 is charged first and which motor vehicles are charged afterwards. The order can be updated each time a connection link 5 is connected or disconnected. In step 9, an enable signal is transmitted. This enable signal allows the motor vehicle 1 to take the charging current tap, at any one time at most one motor vehicle 1 is being charged. This enable signal is specific to the respective motor vehicle 1, so that although the enable signal can be transmitted to all motor vehicles 1, only the selected motor vehicle starts the charging process. This enable signal causes the charging circuit of the motor vehicle 1 to be closed so that the charging current from the charging station 2 is supplied to the motor vehicle 1 via the charging distributor 4 and the connection link 5 and charges its battery. This enable signal can also be wireless, but preferably via the connection link 5, as shown in the present embodiment example. In a preferred embodiment, the enable signal is a modulated voltage signal. In step 10, the charging current is supplied to the motor vehicle. This motor vehicle 1 can now tap charging current until its battery status corresponds to a setpoint value stored in the charging distributor 4. In step 11, the charging distributor 4 registers that the battery status of the vehicle that was the last to receive the enable signal and was charged in step 10 corresponds to the setpoint value and queries whether another motor vehicle 1 has been connected to a connection link 5 or whether the connection link 5 to a motor vehicle 1 has been interrupted. If this is the case, the method is continued at step 7, as in step 8 the queu of motor vehicles 1 ready for charging must be carried out again. Although in a simple embodiment a queue can be created and processed during the current charging tap of the first motor vehicle 1, in the embodiment shown the queue is updated by the steps carried out in step 7. If it is determined in step 11 that the number of connected motor vehicles 1 has not changed, the procedure continues with step 9. If, during the course of the procedure, it is determined that the battery status of each of the connected motor vehicles 1 corresponds to the setpoint value, no further enable signal is sent until the procedure is resumed at step 6 by connecting a connection link to a motor vehicle.

In order to give priority to certain vehicles, a prioritized connection link may be provided. If a motor vehicle 1 is connected to a prioritized connection link in a step 12, the battery status of this motor vehicle 1 is immediately checked in this step 12. If the battery status of this motor vehicle 1 does not correspond to the target value, the procedure is immediately interrupted from step 7 and continues with the vehicle 1 connected to the prioritized connection link at step 8, whereby the vehicle 1 connected to the prioritized connection link is set as the first motor vehicle 1 in the series. Step 12 can take place at any time during the ongoing procedure, whereby a charging current tap of another motor vehicle 1 taking place at this time is also interrupted.

In order to restrict accessibility to the connection links, in an optional process step 13 the connection link 5 can only be made after entering a user authentication. This can be done using an RFID transponder, for example.

As can be seen from FIG. 2, a charging distributor for carrying out the method according to the invention comprises an input 14 for the charging plug of a charging station 2. The charging station 2 is supplied with power via the mains supply 15. The charging current, which can be tapped via the input 13, can be delivered to the connected electric motor vehicles 1 via several connection links 5 arranged on the output side. The connection links 5 to the charging current tap are usually multi-pole. In the example shown, the connection links 5 each end in a CCS type 2 plug 16. The respective poles are 5a the DC+, 5b the DC−, 5c the protective conductor, 5d the proximity contact and 5e the pilot contact. For reasons of clarity of the drawing, the corresponding reference symbols have only been entered for one connection link 5. In this case, the pilot signal, which is fed into the charging distributor 4 via the pilot contact of the charging station 2, is converted into the enable signal by the charging distributor 4 adding an identification signal specific to the selected motor vehicle to the pilot signal. In this embodiment, the plug 16 comprises a signal unit. If the enable signal is transmitted via all connection links 5, this signal unit in the plug 16 checks whether the identification signal of the enable signal matches the motor vehicle 1 connected to the plug 16 and, if it matches, preferably digitally enables the charging current tap. For example, the connection links 5 can be numbered consecutively, with the identification signal specifying the motor vehicles 1 via the number of the respective connected connection link 5. Once a match has been made, the signaling unit can convert the enable signal for the selected motor vehicle 1 back into a pilot signal, so that the signal received by the selected motor vehicle 1 corresponds at all poles to the signal that the vehicle would also receive if it were connected directly to a charging station 2. The signaling circuit, which connects the motor vehicle 1 to the charging distributor 4 via the pilot contact 5e and the protective conductor 5c, can be used to determine the battery status of the motor vehicle 1 directly via the charging station in the same way as the signaling circuit. For this purpose, as described above, the motor vehicle 1 can have an internal, adjustable resistor that is switched into the signaling circuit and one of the adjustable resistance values signals the battery status. An analog-to-digital converter in the charging station 4 is connected to this signaling circuit and thus receives the battery status of the motor vehicles 1 and forwards it to a computing unit 17. This computing unit 17 can be provided in the charging distributor 4 and can also, among other things, sequence the connected motor vehicles 1, determine which motor vehicle 1 receives an enable signal and when, and process the data from the signaling circuits.

One of the connection links 5 shown may be a prioritized connection link, which is treated separately as explained above.

1. A method for charging a plurality of electrically driven motor vehicles via a common charging station the method comprising:
supplying a charging current of the charging station to a charging distributor on its an input side thereof; and
supplying the charging current to the motor vehicles to be charged via an output side of the charging distributor through connection links;
determining a battery status for each of the motor vehicles after connection of the associated connection link thereto;
wherein after the determining of the battery status the connected motor vehicles are queued in a queue, and
carrying out a serial charging process with the charging distributor wherein a transmitted enable signal for a charging current tap that is exclusively for a selected motor vehicle of the queued motor vehicles enables exclusively the selected motor vehicle to tap the charging current until the battery status of the selected motor vehicle corresponds to a setpoint value stored in the charging distributor whereupon another motor vehicle in the queue becomes a next selected motor vehicle and the serial charging process is carried out for the next selected motor vehicle.

2. The method according to claim 1, wherein the enable signal for the charging current tap is transmitted as a modulated voltage signal.

3. The method according to claim 1, wherein a prioritized connection link is connected to one of the motorized vehicles and,
after the determining of the battery status of the motor vehicle connected to the prioritized connection link, the charging distributor interrupts the charging current tap running via one of the connection links and the serial charging process is restarted with the motor vehicle connected to the prioritized connection link as the selected motor vehicle in the queue.

4. The method according to claim 1 wherein the connected motor vehicles are sequentially queued according to times at which the associated connecting links are connected to the motor vehicles.

5. The method according to claim 1 wherein the charging distributor converts a pilot signal transmitted by the charging station into the enable signal for the charging current tap for the selected motor vehicle and the enable signal is transmitted via the connection link thereto.

6. The method according to claim 1 wherein the connection link is only established after a step of authenticating a user.

7. A charging distributor for carrying out a method of charging motor vehicles according to claim 1, said charging distributor comprising:
an input connected with a charging plug of a charging station;
a plurality of connection links configured to supply charging current to the motor vehicles connected therewith;
a receiver determining the battery status of at least one of the connected motor vehicles;
a computing unit communicating with the receiver and supporting a queue of the connected motor vehicles; and
a data link operatively associated with the computing unit and transmitting an enable signal that causes supply of the charging current exclusively to a selected one of the motor vehicles.

8. The charging distributor according to claim 7, wherein the connection links are connected in parallel to one another.

9. The charging distributor according to claim 7, wherein each connection has a respective storage socket.

10. The charging distributor according to claim 7, wherein each connection has an indicator providing a reading to a user of a charging status of the connected motor vehicle.

11. The charging distributor according to claim 8, wherein each connection has a respective storage socket.

12. The charging distributor according to claim 8, wherein each connection has an indicator providing a reading to a user of a charging status of the connected motor vehicle.

13. The charging distributor according to claim 9, wherein each connection has an indicator providing a reading to a user of a charging status of the connected motor vehicle.

14. The charging distributor according to claim 11, wherein each connection has an indicator providing a reading to a user of a charging status of the connected motor vehicle.

15. The method according to claim 2, wherein a prioritized connection link is connected to one of the motorized vehicles and,
after the determining of the battery status of the motor vehicle connected to the prioritized connection link, the charging distributor interrupts the charging current tap running via one of the connection links and the serial charging process is restarted with the motor vehicle connected to the prioritized connection link as the selected motor vehicle in the queue.

16. The method according to claim 2, wherein the connected motor vehicles are sequentially queued according to times at which the associated connecting links are connected to the motor vehicles.

17. The method according to claim 2, wherein the charging distributor converts a pilot signal transmitted by the charging station into the enable signal for the charging current tap for the selected motor vehicle-and the enable signal is transmitted via the connection link thereto.

18. The method according to claim 16, wherein the charging distributor converts a pilot signal transmitted by the charging station into the enable signal for the charging current tap for the selected motor vehicle-and the enable signal is transmitted via the connection link thereto.

19. The method according to claim 18, wherein the connection link is only established after a step of authenticating a user.
